(19) United States
(12) Patent Application Publication
(10) Pub. No.: US 2025/0129950 A1
(43) Pub. Date: Apr. 24, 2025

(54) LIQUID DESICCANT AIR CONDITIONING SYSTEM AND CONTROL METHODS

(71) Applicant: Mojave Energy Systems, Inc., Sunnyvale, CA (US)

(72) Inventors: Rachel ELLMAN, Sunnyvale, CA (US); J.R. HEBERLE, Palo Alto, CA (US); Aaron MELES, Grand Rapids, MI (US); Philip FARESE, New Canaan, CT (US)

(73) Assignee: Mojave Energy Systems, Inc., Sunnyvale, CA (US)

(21) Appl. No.: 18/758,570

(22) Filed: Jun. 28, 2024

Related U.S. Application Data
(63) Continuation of application No. 18/402,365, filed on Jan. 2, 2024, now Pat. No. 12,050,022.
Application No. 18/402,365 is a continuation of application No. PCT/US2023/083438, filed on Dec. 11, 2023.
(60) Provisional application No. 63/387,017, filed on Dec. 12, 2022.

(51) Int. Cl. F24F 5/00; F24F 11/83

(52) U.S. Cl. CPC F24F 5/0014; F24F 11/83

(57) ABSTRACT

Liquid desiccant air conditioning systems and methods to operate them to achieved desired supply air dry bulb temperature and humidity conditions are described herein. In some embodiments, the liquid desiccant air conditioning systems can include a cooling unit, an absorber, a regenerator, and a control unit. The control unit can be operably coupled to the cooling unit, the absorber, and the regenerator such that the control unit can operate the liquid desiccant system to produce a supply air stream at a relatively independent target temperature and humidity. In some embodiments, the control unit can adjust one or more parameters and/or variables of the components of the liquid desiccant system to produce the supply air stream at a high energy efficiency.

### CROSS-REFERENCE TO RELATED APPLICATIONS

This application is a continuation of U.S. patent application Ser. No. 18/402,365, filed Jan. 2, 2024, which is a continuation of International Application No. PCT/US2023/083438, filed Dec. 11, 2023, which claims priority to and the benefit of U.S. Provisional Patent Application No. 63/387,017, entitled “Liquid Desiccant Air Conditioning System and Control Methods,” filed Dec. 12, 2022, the disclosure of each of which is incorporated by reference herein in its entirety.

### TECHNICAL FIELD

The present disclosure relates generally to air dehumidifying systems that utilize liquid desiccant and control methods for the same.

### SUMMARY

The present disclosure describes a highly efficient liquid desiccant air conditioning system that utilizes two moisture removal devices in the cooled air stream, the first being a heat sink that simultaneously cools the air and condenses water out of it, and the second being an absorber unit that dehumidifies the air using a liquid desiccant. A control system adjusts the heat removed from the air stream in response to sensor sensed data of the inlet air stream entering the liquid desiccant system or the supply air stream exiting the liquid desiccant system. Dynamic adjustments by the control system allow relatively independent control of delivered air temperature and humidity, and minimizes overall energy consumption of the liquid desiccant system.

The present disclosure also describes a method of controlling a liquid desiccant air conditioning system including, circulating liquid desiccant at a liquid desiccant flow rate between an absorber unit and desorber unit, cooling an inlet air stream flowing through the liquid desiccant air conditioning system to form a precooled inlet air stream having a precooled temperature value and a precooled humidity value, regeneration air temperature and flow rate, vapor compression, and others, as described in further detail below. Depending on the temperature and humidity of the inlet air and of the precooled inlet air, moisture may be removed from the air stream by condensation, producing a first moisture removal rate. The cooled inlet air is then passed through the absorber unit. The liquid desiccant contacts the precooled inlet air stream and removes water from the precooled inlet air stream to form a supply air stream having a supply air absolute humidity value that is less than the precooled absolute humidity value, producing a second moisture removal rate, and forming a loaded liquid desiccant. The method also includes heating a regeneration air stream flowing through the liquid desiccant air conditioning system, and flowing the loaded liquid desiccant through the desorber unit, where the liquid desiccant contacts the heated regeneration air stream, and the heated regeneration air stream removes water from the loaded liquid desiccant to form a regenerated liquid desiccant and a humidified exhaust air stream. An embodiment of the method includes energizing a heat pump to cool the cooled inlet air stream to the cooled temperature value and heat the heated inlet air stream to the heated temperature value. The embodiment includes adjusting a heat pump heat flow rate value to achieve a predetermined supply air humidity value and temperature by manipulating the precooled air temperature value, the first moisture removal rate, and the second moisture removal rate, with the first moisture removal rate being primarily controlled by the precooled inlet air temperature setpoint, the second moisture removal rate being primarily controlled by the liquid desiccant concentration, which is itself determined by the heated temperature value and heated humidity value.

The present disclosure also describes a liquid desiccant air conditioning system including, a liquid desiccant loop having an absorber unit in fluid communication with a desorber unit and liquid desiccant flowing between the absorber unit and the desorber unit. The system includes a supply airflow path passing through the absorber unit and forming an absorber liquid/air and/or liquid/gas interface within the absorber unit and a conditioned supply airflow exiting the absorber unit. A sensor is configured to measure a conditioned supply airflow temperature and humidity value. A regeneration airflow path passes through the desorber unit and forms a desorber liquid/air interface within the desorber unit and an exhaust airflow exiting the desorber unit. In some embodiments, a heat pump is thermally coupled to the supply airflow path and removing heat and moisture via condensation from supply airflow upstream of the absorber unit. The heat pump is thermally coupled to the regeneration airflow path adding heat to regeneration airflow upstream of the desorber unit. The heat pump has a power unit providing power to the heat pump to cool the supply airflow and heat the regeneration airflow. A controller is operably connected to the sensor and the power unit. In some embodiments the controller is configured to adjust the operation of the power unit based on the system parameters including the evaporator leaving air temperature, the condenser leaving air temperature, the temperature of the refrigerant after condensing, the temperature of the refrigerant at the evaporator, and/or the configuration of various valves, to achieve the desired supply air temperature and humidity.

### BRIEF DESCRIPTION OF THE DRAWINGS

The discussion below makes reference to the following figures, wherein the same reference number may be used to identify the similar/same component in multiple figures. The figures are not necessarily to scale.

FIG. 1 is a schematic diagram of an illustrative liquid desiccant system, according to an embodiment.

FIG. 2A is a psychrometric diagram of an illustrative liquid desiccant system process, according to an embodiment.

FIGS. 2B and 2C are psychometric diagrams illustrative of operation modes of a liquid desiccant system that prioritizes supply air dew point relative to supply air dry bulb temperature, according to an embodiment.

FIGS. 3A and 3B are psychrometric diagrams illustrative of an operation mode of a liquid desiccant system that prioritizes supply dry bulb temperature relative to supply air dew point, according to an embodiment.

FIG. 4 shows the performance of a liquid desiccant system according to an embodiment.

FIG. 5 shows a method for conditioning a supply air stream with a liquid desiccant system, that prioritizes supply air dew point relative to supply air dry bulb temperature, according to an embodiment.

FIG. 6 shows a method for conditioning a supply air stream with a liquid desiccant system, that prioritizes supply air dew point relative to supply air dry bulb temperature, according to an embodiment

FIG. 7 shows a method for conditioning a supply air stream with a liquid desiccant system, that prioritizes supply dry bulb temperature relative to supply air dew point, according to an embodiment.

### DETAILED DESCRIPTION

The present disclosure is generally related to heating, ventilation, and air-conditioning (HVAC) systems and control methods for the same. In one example embodiment, a gas-to-liquid vapor exchanger includes an absorber unit to extract moisture from air into a liquid desiccant and a desorber unit to regenerate a liquid desiccant passing through both units. These units can be used to absorb and desorb water vapor into and out of the liquid desiccant to dehumidify or humidify air. This humidification and dehumidification can be used in HVAC heating and cooling applications. Unit operation control of the liquid desiccant system minimizes energy consumption.

Air conditioning systems may simultaneously perform two functions: first to dehumidify and second to cool a forced air stream. Commonly used air conditioning systems use vapor compression, which can both cool the incoming air and dehumidify it by cooling it below the dew point temperature of the air, thus condensing water. However, given a humid air stream, vapor compression may rely on cooling the air stream to below its desired delivery temperature to condense the moisture and achieve a low absolute humidity, then re-heating the air to its desired delivery temperature. This moisture condensation process dramatically increases the energy requirement of air conditioners, especially in humid climates. An alternative dehumidification method, known as liquid desiccant dehumidification, can substantially decrease the energy intensity of air conditioning, and is the subject of the present disclosure.

Removing moisture from air using a liquid desiccant is an energy-efficient alternative to vapor compression, since it minimizes or removes the need for excessive cooling and reheating of the air stream, as well as improving the coefficient of performance of an integrated heat pump by raising the low temperature required from the heat pump, which reduces heat pump energy consumption. In a liquid desiccant dehumidification system, the humid air exchanges water vapor with the liquid desiccant. A gas-to-liquid vapor exchanger (absorber unit) may be used to contact humid air and a liquid desiccant and transfer water vapor in the humid air into the liquid desiccant to form a loaded liquid desiccant. This loaded liquid desiccant may be regenerated in a gas-to-liquid vapor exchanger (desorber unit) by heating the loaded liquid desiccant to evaporate and/or drive off water vapor and return the regenerated liquid desiccant to the absorber unit. Alternatively, a loaded liquid desiccant may be regenerated by an electrochemical process (such as electrodialysis) or other process that separates the desiccant into a more dilute and a more concentrated portion of desiccant. The rate of regeneration of the desiccant in the desorber, specifically relative to the rate of collection of moisture in the absorber, will change the concentration of the desiccant. The liquid desiccant's potential for humidity absorption is governed by its concentration, with absorption potential increasing with higher concentration. Operating at higher concentrations enables a higher moisture removal rate from the air stream, however, higher concentrations require higher temperatures to regenerate. Increasing the temperature required from the heat pump to regenerate the desiccant reduces the coefficient of performance of the heat pump, resulting in higher heat pump energy consumption.

An advanced liquid desiccant system pre-cools (removes heat from) inlet air entering the absorber unit and pre-heats (adds heat to) inlet air entering the desorber unit. A heat pump may be used to move the heat from one unit to the other unit to reduce energy consumption of the overall liquid desiccant system. The liquid desiccant system and control method described herein may maximize an energy efficiency of the overall liquid desiccant system at a selected set of system air flow inlet parameters and desired outlet parameters. More specifically, for example, evaporator temperature, condenser temperature, and desiccant concentration can be accounted for and selectively manipulated to minimize or optimize energy use for various combinations of air inlet and outlet conditions.

Liquid desiccant air conditioning systems and methods described herein utilize two moisture removal devices in the supply air stream. The first moisture removal device is a heat sink that cools the air (also referred to herein as the cooling unit) and may remove moisture from the air by cooling the air below its saturation point and condensing water. A control system can adjust the temperature of the cooling unit, and thus the precooled air temperature and dew point, as well as a rate of moisture removal and/or condensation (if any) by that unit. The second moisture removal device is the liquid desiccant absorber, which uses the liquid desiccant to transfer water vapor from the cooled air to the desiccant. A control system can adjust the amount and/or quality of heat transferred into the desiccant in the regenerator thus changing the rate of regeneration and the desiccant concentration. Changing the desiccant concentration will change the temperature and/or humidity of the supplied air.

In one embodiment, a control system can adjust the heat flow in response to inlet and/or outlet temperature and/or humidity sensor sensed data of the inlet air stream entering the liquid desiccant system and/or the supply air stream exiting the liquid desiccant system. These adjustments affect the moisture removal rate of the cooling section (by adjusting the temperature of the cooling unit and thus the amount of water condensed out of the air) and the moisture removal rate of the liquid desiccant absorber (by controlling the desiccant concentration via the amount and/or quality of heat transferred to the desiccant in the desorber). These adjustments affect the low and high temperatures required in the system. If changes in these temperatures result in changes in energy consumption, such as in a heat pump, these dynamic adjustments by the control system can be used to minimize overall energy consumption of the liquid desiccant air conditioning system.

In some implementations, a liquid desiccant air conditioning system can be configured to select the highest temperature of operation of the cooling unit (e.g., also referred to as cooling temperature) that results in a moisture removal rate and desiccant concentration in the absorber that can be desorbed at that minimum condenser temperature, resulting in the lowest compressor lift and highest coefficient of performance (COP) for the refrigeration system.

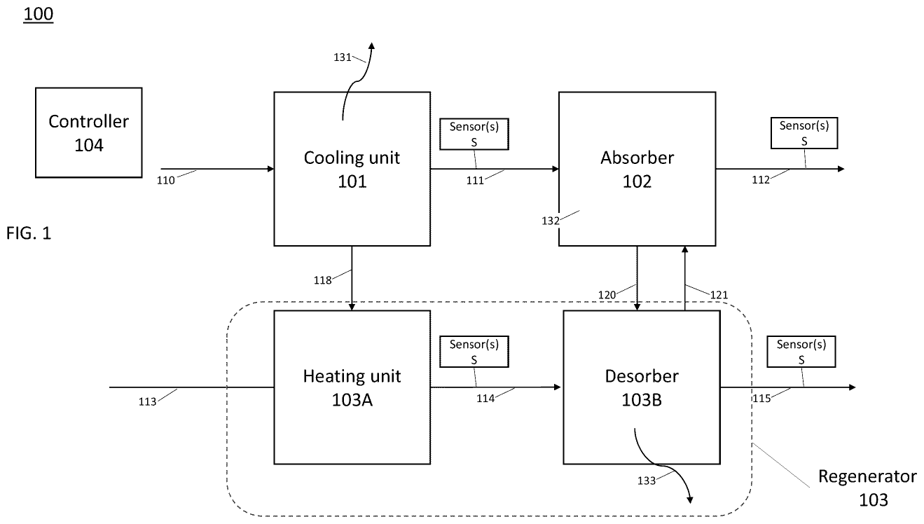

FIG. 1 is a schematic diagram of the air, water, and heat flows in a liquid desiccant system 100, according to an embodiment. The liquid desiccant system 100 includes a cooling unit 101, an absorber 102, a thermal regenerator 103, which includes a desorber 103B configured to remove moisture from loaded desiccant, and a heating unit 103A to provide heat to the desorber 103B for the moisture removal, and a controller 104. The cooling unit 101 is operably coupled to the absorber 102 and the regenerator 103, and the absorber 102 is operably coupled to the regenerator 103, as shown in FIG. 1. In some embodiments, the system 100 can optionally also include one or more sensors S configured to measure various system conditions, including, for example, temperature, humidity, pressure, and/or any other suitable parameters to assist in operation and control of the system 100. In such embodiments, the sensors S can be placed in any suitable location within the system 100. For example, as shown in FIG. 1, one or more sensors can be placed to measure the temperature of air 111 exiting the cooling unit 101; one or more sensors can be placed to measure the temperature and humidity of the supply air 112 exiting the absorber 102; and one or more sensors can be placed to measure the air 115 exiting the regenerator 103 (and more specifically, the desorber 103B), as described in further detail below. In some embodiments one or more sensors can be placed to measure one or more parameters of the heating unit and/or cooling unit such as the temperatures of these units. In the case where these units are operably connected to each other via a heat pump, one or more sensors can be placed to measure the operating parameters of the heat pump such as the discharge pressure (which can be also used to determine the condensing temperature), condensing temperature, suction pressure (which can also be used to determine the evaporating temperature), and/or evaporating temperature.

The liquid desiccant may be any suitable liquid desiccant. In some implementations, the liquid desiccant can be a halide salt solution, including, for example, sodium chloride (NaCl), potassium chloride (KCl), potassium iodide (KI), lithium chloride (LiCl), copper(II) chloride (CuCl₂), silver chloride (AgCl), calcium chloride (CaCl₂)), chlorine fluoride (ClF), bromomethane (CH₃Br), iodoform (CHI₃), hydrogen chloride (HCl), lithium bromide (LiBr), and/or hydrogen bromide (HBr). In some embodiments, the halide salt solution is selected from LiCl, NaCl, LiBr, and/or CaCl₂). In some embodiments, the halide salt solution is LiCl. In some implementations, the solution may be water and described as an aqueous solution. The halide salt may be present in the liquid desiccant in a range from about 2% to about 50% wt, or in a range from about 10% to about 40% wt, or in a range from about 20% to about 40% wt.

The controller 104 is operably coupled (e.g., physically and/or wirelessly/remotely) to the cooling unit 101, absorber 102, the regenerator 103, and the sensors S. The controller 104 can be any suitable controller configured to send signals to and/or receive signals from the cooling unit 101, absorber 102, the regenerator 103, and the sensors S, to monitor and control operation (e.g., setpoints) of the same. The controller 104 can include a memory (not shown), a processor (not shown), and an input/output (I/O) device (not shown).

The cooling unit 101 may be any suitable heat sink configured to remove heat from the air, such as, for example, a refrigerant-to-air coil, a chilled water coil, indirect evaporative cooler, and/or the like. As described in more detail herein, and shown in FIG. 1, the cooling unit 101 is configured to receive and cool inlet air 110 to a cooling temperature (also referred to as a precool temperature setpoint) to produce a cooled air 111. In some embodiments, the cooling temperature can be equal to and/or lower than the saturation temperature of the inlet air 110 (e.g., the inlet air 110 is cooled in the absorber 102 up to or beyond the inlet air's dew point) to thereby condense moisture and/or water from the inlet air 110 and produce condensate at condensate moisture removal rate 131. That is to say, in some embodiments the cooling unit 101 can cool and/or precool the inlet air 110 effectively conducting a first stage and/or step dehumidification of the inlet air 110 in which moisture and/or water is removed from the inlet air 110 to produce a cooled air 111 and a condensate at a condensate moisture removal rate 131. The cooled air 111 can then be further dehumidified in a second stage and/or step dehumidification in the absorber 102, as further described herein. In some implementations, the cooling unit 101 includes a cooling coil that is an evaporator of a heat pump. In some embodiments, the liquid desiccant system 100 can include a sensor disposed between the cooling unit 101 and the absorber 102, as shown in FIG. 1. In some implementations, this sensor can be configured to measure the cooling temperature, a humidity of the cooled air 111, or both. The sensor can then send a signal to the controller 104 such that the controller 104, in response to receiving the signal, adjusts at least one of the cooling temperature, the absorber moisture removal rate 132 or the desorber moisture rejection rate 103, as further described herein.

The absorber 102 is configured to receive the cooled air 111 which has been cooled and may be partially dehumidified by cooling unit 101. The absorber 102 can be configured to further dehumidify the cooled air 111 by interfacing (e.g., exposing) the cooled air 111 with a concentrated liquid desiccant 121, causing absorption of water vapor from the cooled air 111 into the concentrated liquid desiccant 121 and formation of a supply air 112, as described in further detail herein. The concentrated liquid desiccant 121 can absorb water vapor from the cooled air 111 at an absorber moisture removal rate 132. The absorber 102 defines a liquid/air and/or liquid/gas interface and may be formed by any vapor/liquid mass transport unit operation, including, for example, packed beds, tray towers, spray towers, bubble columns, membranes, and/or the like. As the concentrated liquid desiccant 121 absorbs water vapor from the cooled air 111, the concentration of liquid desiccant decreases. The liquid desiccant produced in the absorber 102 after exposure to the cooled air 111 can be referred to as a loaded liquid desiccant 120. The loaded liquid desiccant 120 can be regenerated (by removing the moisture and/or water from the loaded liquid desiccant 120), so that it can then be used again in the absorber 102 to remove additional water vapor (e.g., moisture) from the cooled air 111.

To that end, the regenerator 103 is configured to regenerate the loaded liquid desiccant 120. More specifically, the desorber 103B of the regenerator 103 is configured to receive the loaded liquid desiccant 120 from the absorber 102, remove moisture and/or water from the loaded liquid desiccant 120, produce the regenerated and/or concentrated liquid desiccant 121, and then convey the regenerated and/or concentrated liquid desiccant 121 back to the absorber 102. The desorber 103B defines a liquid/air and/or liquid/gas interface that may be formed by any vapor/liquid mass transport unit operation, including, for example, packed beds, tray towers, spray towers, bubble columns, membranes, and the like. The desorber 103B can be coupled to the absorber 102 to receive the loaded liquid desiccant 120 and then remove moisture and/or water from the loaded liquid desiccant 120 at a desorber moisture rejection rate 133. The regenerator 103, in this embodiment contains a heating unit 103A configured to convey to the desorber 103B heat via a pre-heated air stream 114 to separate the moisture and/or or water from the loaded liquid desiccant 120 in the desorber 103B. In some embodiments, heat and/or heated air can be conveyed to the desorber 103B in other ways, e.g., without a heating unit in the regenerator, as described in further detail herein. In some embodiments, the liquid desiccant system 100 can include a sensor disposed between the heating unit 103A and the desorber 103B, as shown in FIG. 1. In some implementations, this sensor can be configured to measure a temperature of the pre-heated air stream 114 and send a signal to the controller 104 such that the controller 104, in response to receiving the signal, adjusts at least one of the cooling temperature, the absorber moisture removal rate 132 or the desorber moisture rejection rate 103, as further described herein.

The heating unit 103A can provide heat from one or more of any suitable sources, including, for example, excess heat 118 from the cooling unit 101, as illustrated in FIG. 1. Other examples include electric heat, gas-fired heat, hot water, steam, solar heat, geothermal heat, and/or the like. In some implementations the heating unit 103A can include a fan and a heating coil that can be used to transfer heat to the regeneration air 113 to produce the pre-heated air stream 114. The controller 104 can be operably coupled to the heating unit 103B to change and/or modify a volume of air passing through the heating coil to control the temperature of the pre-heated air stream 114. For example, in some implementations the volume of air passing through the heating coil can be controlled by changing a speed of the fan in the heating unit 103A, and/or a pressure drop of the air passing through the heating coil. In some implementations, the heating unit 103A includes a condenser of a heat pump to transmit heat to a regeneration air 113. In some implementations, the heat pump can cool the evaporator and heat the condenser. In use, in some implementations, the heat pump may be capable of operating at variable flow (e.g., adjusting a flowrate of a refrigerant and/or working fluid circulating within the heat pump) to change the amount of heat transported between the evaporator and condenser, thereby providing the system 100 is controllability. For example, in some embodiments the heat pump may be capable of adjusting a speed of a refrigerant compressor to alter, change, and/or modify the mass flow rate of refrigerant circulating within the heat pump.

Although not shown, in some embodiments, the regenerator 103 can be an electrochemical regenerator (and as such may not include a heating unit) and would use an electric current to regenerate the loaded liquid desiccant 120 and produce regenerated and/or concentrated liquid desiccant 121.

Although not shown, in some embodiments, the system 100 may include an auxiliary condensing coil configured to receive an external air stream other than the regeneration air stream (113 to 114) to remove unneeded heat from the system 100. For example, in some embodiments the system 100 may include an auxiliary condensing coil configured to receive an external air stream and flow the external air stream through the heating unit 103A to remove unneeded heat generated in the cooling unit 101. In such embodiments, in some implementations, one or more valves may be included (e.g., one or more vales disposed between the auxiliary condensing coil and a condenser of the heating unit 103A) to provide the ability to vary (e.g., with the aid of the controller 104) the amount of heat sent to the heating unit 103A vs. the external air stream. In some implementations, the amount of heat sent to the heating unit 103 can be adjusted by varying a speed of a fan drawing the external air stream t the auxiliary condensing coil. Alternatively, in some implementations, the amount of heat sent to the heating unit 103 can be adjusted by varying a pressure drop of the external air stream.

In use, inlet air 110 enters the cooling unit 101 and is cooled to a predetermined and/or preferred cooling temperature (also referred to as a precool temperature setpoint) within the cooling unit 101. If the dew point of inlet air 110 is higher than the precool temperature setpoint, moisture and/or water will be condensed out of the inlet air 110, forming (a) a condensate at a condensate moisture removal rate 131, and (b) a cooled air 111 (also referred to as precooled air 111). Said in other words, in some embodiments the cooling unit 101 can receive the inlet air 110, cool the inlet air 110 (e.g., reduce the enthalpy of the inlet air 110) to a predetermined and/or preferred cooling temperature (e.g., a temperature lower than the dew point of the inlet air 110) which results in a first stage and/or step dehumidification of the inlet air 110 and producing a cooled air 111 (at a cooled air humidity) which can be further dehumidified in the absorber 102, as further described herein. The cooled air 111 can exit the cooling unit 101 and then be directed and/or flown from the cooling unit 101 to the absorber 102, where the cooled air 111 is introduced to a concentrated liquid desiccant 121 flowing within the absorber 102. Exposure of the cooled air 111 to the concentrated liquid desiccant 121 causes absorption of water vapor from the air stream 111. The absorption of water vapor from the cooled air 111 into the concentrated liquid desiccant 121 dehumidifies the cooled air 111 and produces a supply air 112 at a target supply air temperature and humidity, and a loaded liquid desiccant 120, as shown in FIG. 1. In some embodiments, the absorption of water vapor from the cooled air 111 in the absorber 102 can constitute a second stage and/or step dehumidification of inlet air 110 (e.g., after the inlet air 110 is flown through the cooling unit 101 and is cooled to a predetermined temperature lower than the dew point of the inlet air 110). Supply air stream 112 exits the absorber 102 at a supply air humidity and temperature setpoint. The loaded liquid desiccant 120 (i.e., the liquid desiccant after having absorbed water vapor from the cooled air 111 within the absorber 102) is transferred from the absorber 102 to the regenerator 103 (in this case, the desorber 103B of the regenerator). In some embodiments the desorber 103B can expose the loaded liquid desiccant 120 to a pre-heated air stream such as pre-heated air 114 in FIG. 1. In some embodiments, the pre-heated air 114 maybe produced by flowing a regeneration air 113 through the heating unit 103A. In some embodiments, the heating unit 103A can be configured to heat the regeneration air 113 by transferring, for example, heat from the heat absorbed in the cooling unit 101 using a heat pump (not shown). The pre-heated air stream 114 can enter the desorber 103B and come in contact with the loaded liquid desiccant 120 flowing and/or circulating within the desorber 103B, thereby absorbing water from the loaded liquid desiccant 120 and regenerating the loaded liquid desiccant 120 to create the regenerated and/or concentrated liquid desiccant 121, which can then be used in the absorber 102. The regenerated and/or concentrated liquid desiccant 121 is then returned from the desorber 103B to the absorber 102. In some embodiments, the liquid desiccant system 100 can optionally include an auxiliary condensing coil configured to receive an external air stream (other than the regeneration stream 113 or 114) to remove unneeded heat from the heating unit 103A. In some embodiments, a user and/or subject may want to use the liquid desiccant system 100 to produce a supply air 112 having a predetermined and/or preferred supply air humidity and temperature. The controller 104 may be operably coupled to the cooling unit 101, the absorber 102, and the regenerator 103 to adjust and/or control one or more parameters of the liquid desiccant system 100 such as for example, a flowrate of inlet air stream 110, a cooling temperature in the cooling unit 101, an amount of heat transferred and/or directed to the desorber 103b, and/or a concentration of the liquid desiccant directed to the absorber 102, to produce a flowrate of a supply air 112 at the predetermined (e.g., target) supply humidity and temperature, as further described herein. In some implementations, the liquid desiccant system 100 can include a sensor disposed downstream of the absorber 102, as shown in FIG. 1. This sensor can be configured to measure the air supply temperature, and/or the air supply humidity, and then send to the controller 104 a signal indicative and/or associated to the measured air supply temperature and/or air supply humidity. The controller 104 can receive the signal from the sensor and determine a temperature difference between the measured air supply temperature and a target air supply temperature stored in a memory of the controller 104. Similarly, the controller 104 can be configured to determine a humidity difference between the measured air supply humidity and a target air supply humidity stored in the memory of the controller 104. In some implementations the controller 104 can be further configured to determine, based on the measured air supply temperature and air supply humidity, other characteristics and/or properties of the air supply such as, for example, an air supply dry bulb temperature and/or an air supply dew point. The controller can store additional target parameters and/or characteristics of the supply air stream target defined by a user. For example, the controller 104 can be configured to store a target supply air dew point, and/or a target supply air dry bulb temperature. In such implementations, the controller can determine, for example, a difference between a received air supply humidity and a target air supply dew point, or a difference between a supply air dry bulb temperature and a target supply air dry bulb temperature. In some implementations, the controller 104 can be configured to adjust one or more operating conditions of the liquid desiccant system 100 to keep the air supply humidity within 0.10 degrees, within 0.20 degrees, within 0.25 degrees, within 0.50 degrees, within 1.0 degree, within 2.0 degrees, within 3.0 degrees, or within 5.0 degrees of a target air supply dew point. In some implementations, the controller 104 can be configured to adjust one or more operating conditions of the liquid desiccant system 100 to keep the air supply dry bulb temperature within 0.10 degrees, within 0.20 degrees, within 0.25 degrees, within 0.50 degrees, within 1.0 degree, within 2.0 degrees, within 3.0 degrees, or within 5.0 degrees of a target air supply dry bulb temperature.

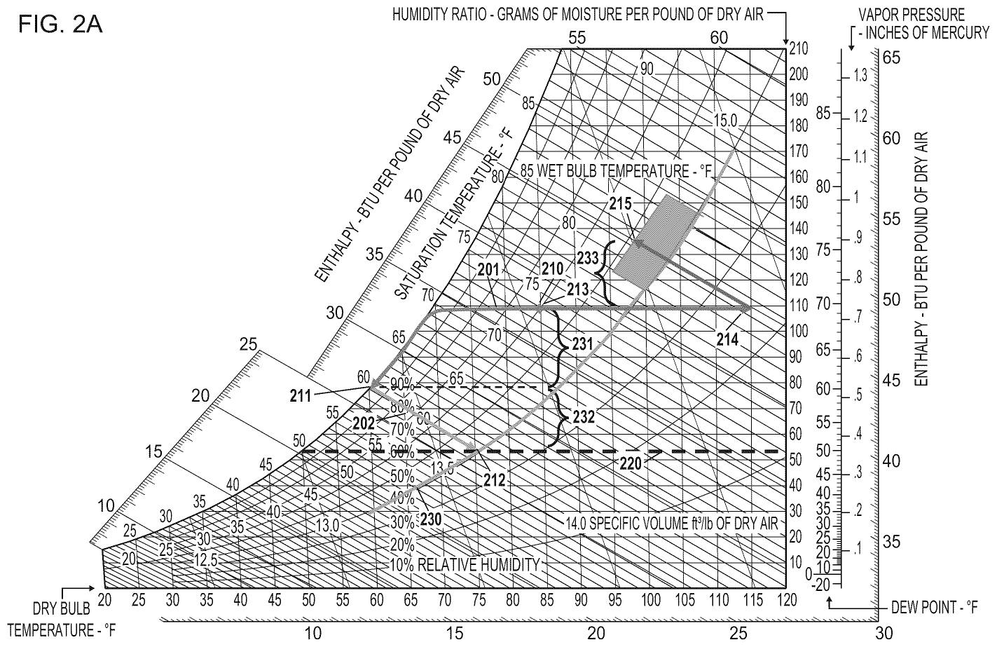

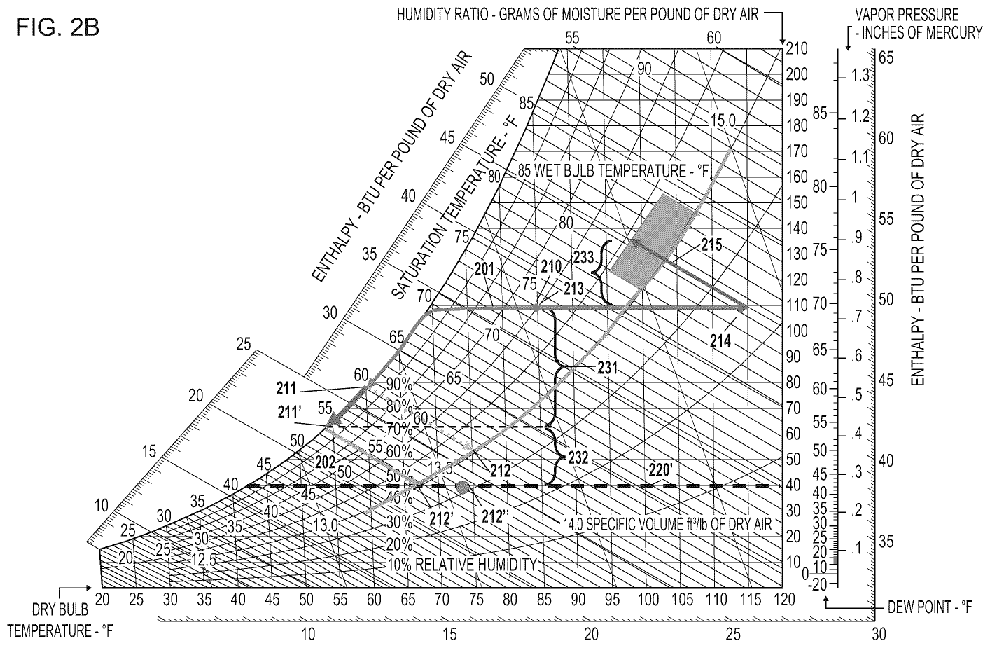

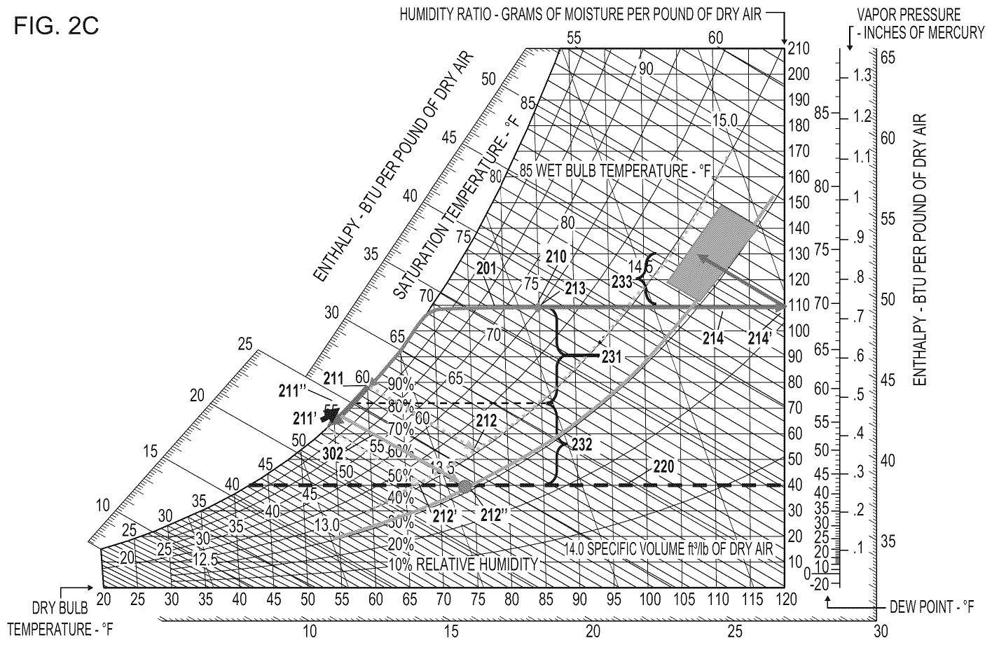

The condensate moisture removal rate 131 (as discussed in further detail with respect to FIG. 2A, with reference to 231) is substantially determined by the flow rate and absolute humidity of the inlet air 110 and the temperature of the cooling coil (not shown) within the cooling unit 101. The absorber moisture removal rate 132 (as discussed in further detail with respect to FIG. 2A, with reference to 232) is substantially determined by the cooled air 111 flow rate and the concentration of the desiccant stream 121. The absorber moisture removal rate 132 (as discussed in further detail with respect to FIG. 2A, with reference to 232) can be determined by moisture data measured by a sensor at 111 and at 112 (i.e., upstream and downstream the absorber 102). The desorber moisture rejection rate 133 (as discussed in further detail with respect to FIG. 2A, with reference to 233) is substantially determined by the flow rate and absolute humidity of the regeneration air 113, the concentration of desiccant stream 120, and the temperature at which the pre-heated air stream 114 is delivered. Accordingly, stable operation of the unit results when the moisture absorber rate in the absorber 102 equals the desorber moisture rejection rate 133 in the regenerator 103. This state can be achieved by controlling the temperature of the cooling unit 101 and the temperature of the heating unit 103A. Further, the rate at which the system becomes stable is set by the liquid desiccant concentration which in turn has been set by the rates of moisture accumulation in the absorber (e.g., the absorber moisture removal rate 132) and regeneration in the desorber (e.g., the desorber moisture rejection rate).

In some implementations, it is desirable to control both the temperature and humidity of the supply air stream 112. This may be achieved by delivering a particular temperature of air stream 111 and concentration of liquid desiccant stream 121 to absorber 102. The concentration of the desiccant stream 121 may be controlled by controlling the desorber moisture rejection rate 133 of the regenerator 103 which in turn can be controlled by controlling one or more of the following parameters: the temperature of the pre-heated air stream 114, the amount and/or quality of heat input (e.g., from heating unit 103A) to the desorber 103B, the amount of regeneration air 113 delivered to the regenerator 103, and/or the flow rate of the liquid desiccant 120 & 121 flowing between the absorber 102 and the desorber 103B. In some embodiments, e.g., in implementations in which the regenerator is an electrochemical regenerator, the regeneration rate of the regenerator can be controlled by the amount of current delivered.

In some implementations, a volume of desiccant in the system is relatively large, making changes in desiccant concentration 121 slower than the cooling unit 101 can change temperature to impart a desired change to the supply air 112. In the event of a rapid change in the required moisture removal rate of the liquid desiccant system 100 (e.g., the change is required in a time period not reachable by changes to the desiccant concentration alone), the control system 104 can increase the condensate moisture removal rate 131 by decreasing the cooling temperature and/or precool temperature setpoint of cooled air 111 until the liquid desiccant concentration in the concentrated liquid desiccant 121 can be sufficiently increased to increase the absorber moisture removal rate 132, as described in more detail with respect to FIGS. 2A-C.

In some implementations, a heat pump (not shown) can be used to move a heat stream 118 from the cooling unit 101 to the heating unit 103A. The coefficient of performance of the heat pump, and therefore its energy consumption, increases with decreasing difference between the temperature of the cooling unit 101 and the heating unit 103A. However, in some instances, it is the state of supply air 112 that is desired to be controlled to a target temperature, humidity, or both. Therefore, to accommodate such instances, the energy consumption of the heat pump could potentially be minimized by maximizing the temperature of the cooling unit 101 and minimizing the temperature of the heating unit 103A while simultaneously satisfying the target setpoints (target temperature and/or humidity) of the state of supply air 112.

FIGS. 2A-2C show psychrometric diagrams of an illustrative liquid desiccant system process, according to an embodiment, and illustrates how the system may manipulate the condensation moisture removal rate and absorber moisture removal rate to achieve a desired system moisture removal rate. The system can be, for example, similar to or the same as, in function and/or form, any of the liquid desiccant systems described herein, e.g., system 100.

Various control protocols may be employed by any of the liquid desiccant control systems described herein. In some cases, for example, the control system may adjust the rate at which the regenerator removes water from the desiccant in the regenerator (e.g., the desorber moisture rejection rate) for example by increasing the quality or amount of heat entering the desorber to match the collection rate of water in the absorber (e.g., the absorber moisture removal rate). In some cases, the control system may further adjust the rate of regeneration to change the concentration of the desiccant to achieve a desired temperature and/or humidity of air in the supply air outlet. In some cases, the control system can adjust the temperature of a cooling coil in the cooling unit, and adjust the desiccant concentration, to independently control the temperature and humidity of the supply air. In some cases, the temperature of the cooling coil in the cooling unit may be adjusted without colleting and/or regenerating moisture to cool the supply air. In some cases, the temperature of the cooling coil and the desiccant concentration can be varied to optimize (e.g., minimize energy usage) to provide supply air at a desired humidity (e.g., humidity ratio or absolute humidity) at the supply air outlet.

The regeneration rate (e.g., the desorber moisture rejection rate) can be varied in one or more manners, including, for example, for thermal regeneration systems, adjusting the temperature of the heated coil; adjusting the heat provided to the heated coil; adjusting the amount of heat transferred into the air in the regeneration pathway vs external coil (e.g., unneeded heat) (e.g., by varying the flow of refrigerant to each coil and thus the amount of unneeded heat available to be removed from the system by the second condensing coil in the external air stream; and/or by varying the airflow across the external coil and thus the heat available for regeneration by the heating coil); adjusting the air flow rate across the heating unit and/or desorber, adjusting the desiccant flow rate (e.g., modulation, and/or on/off as needed). The regeneration rate can be varied in one or more manners, including, for example, for electrochemical regeneration systems, by varying the voltage across the device, the flow path within the device, and/or the flow rate of desiccant to the device.

The temperature of the evaporator can be varied, for example, by changing the flow rate of refrigerant (e.g., by varying the speed of the compressor, by operating one or more compressors in tandem), and/or by modulating the amount of refrigerant sent through a hot-gas bypass.

In some embodiments, the control system can be configured to operate in several modes, and switch between modes automatically (e.g., based on sensed data and/or user inputs of set points) including, for example, entering a dehumidification mode when the supply inlet dew point is at higher dew point than the desired supply outlet; entering a cooling mode when the supply inlet is at a higher dry bulb than the desired supply outlet dry bulb; entering a ventilation mode when the supply air inlet is at a lower dry bulb and lower dew point than the desired supply outlet dew point and dry bulb; and/or transitioning between states as the supply inlet air changes such that appropriate delays and dead bands are applied.

In some embodiments, any of the liquid desiccant systems described herein may include two proportional-integral-derivative controllers and control loops, including a loop that monitors the supply air dew point, and when too high compared to the desired target, the system can lower the cooling temperature in the cooling unit, and when too low compared to the desired target, the system can raise and/or increase the cooling temperature in the cooling unit; and a loop that monitors the actual supply air temperature (e.g. the air supply temperature measured with the sensors S) and supply air target temperature, and accordingly determines the appropriate desiccant concentration which it controls by determining how much water to regenerate in the desorber, e.g., by how much heat to convey to the desorber-if actual supply temperature is less than supply target temperature, the system can decide to increase the amount of heat to the regenerator to increase the desiccant concentration and thus to increase the actual supply temperature while the first loop maintains the desired supply air dew point.

FIGS. 2A-2C illustrate using a psychometric chart how a liquid desiccant air conditioner control system 2000 (including any of the control systems described herein) can condition air to meet target humidity and temperature set points. The liquid desiccant system 200 can be structurally and/or functionally similar to the liquid desiccant system 100 described above with reference to FIG. 1. For example, the liquid desiccant system 200 can include one or more components that are structurally and/or functionally similar to components of the liquid desiccant system 100. Consequently, no further details regarding the components of the liquid desiccant system 200 are provided herein.

As shown in FIG. 2A, in this example, inlet air 210 has a certain temperature and humidity shown on the diagram (about 85 degrees F. dry bulb and about 70 degrees F. dew point), and a target temperature and target dew point for the supply air 212 are set to about 75 degrees F. dry bulb and about 50 degrees F. dew point. The inlet air can be cooled and dehumidified (illustrated along the line 201 in FIG. 2A), e.g., by a cooling unit similar to the cooling unit 101 described above with reference to FIG. 1, to a cooling temperature and/or precool temperature 211. As the dew point of inlet air 210 is above the dew point of the precool temperature 211, water is condensed out of the air, resulting in a condensate moisture removal rate 231. This is illustrated by the line 201 that first traverses horizontally to its left as it is cooled and until it reaches its dew point or saturation temperature, at which point additional cooling results in condensation (and dehumidification), as illustrated with the line 201 traversing down left along the saturation curve, to 211. The cooling unit 201 produces a cooled air 211 which is further dehumidified by a liquid desiccant at a concentration with equilibrium vapor pressure 230 in a liquid desiccant absorber similar to the absorber 102 described above with reference to FIG. 1. The liquid desiccant absorbs water vapor from the cooled air 211 as illustrated by the line 202 in FIG. 2A, resulting in absorber moisture removal rate 232. The result of these two processes is a supply air 212 at target temperature and state 212, which is at the target dew point 220. So, described another way, with a target temperature and dew point for the supply air 212, the inlet air 210 can be selectively cooled and dehumidified to a target enthalpy, and then further dehumidified (and heated) at or near constant enthalpy to reach the target temperature and humidity set points for the supply air 212.

Also as illustrated in FIG. 2A, the heat required for regeneration, which in some embodiments is moved (e.g., by the cooling unit) from the inlet air 210 to the regeneration air stream, 213, preheats the airstream entering the desorber (as illustrated by the horizontal line connecting 213 and 214). In some implementations this air stream to be preheated, 213, is at the same inlet conditions as the inlet air 210 to the cooling unit 201 (or at least substantively similar, e.g., if coming from the same or similar environment). The pre-heated air 214 is used to heat and thereby regenerate the loaded liquid desiccant (as illustrated by the line connecting 214 and 215 traversing up and to its left and towards the constant relative humidity line 230 and exiting the desorber at 215). In some implementations, the temperature and/or amount of the pre-heated air 214 entering the desorber can be measured with a sensor, and used to control the desorber moisture rejection rate 233, i.e., the regeneration rate of the desorber.

As illustrated in FIG. 2B, the supply air conditions are changed from FIG. 2A from about 75 degrees F. dry bulb and about 50 degrees F. dew point (212) to about 73 degrees F. dry bulb and about 40 degrees F. dew point (212″), e.g., by an operator who desires less humid air or by a controller with a schedule of temperature set points. In one operating mode, e.g., a mode that prioritizes the supply air dew point, the system gives priority to reaching the target dew point of 40 degrees F. (220′) by relatively quickly lowering the temperature of the air leaving the cooling unit from 211 to 211′. As a result, the supply air 212′ leaving the absorber is at the target dew point (220′), but the target temperature for the supply air has decreased to about 67 degrees F. dry bulb.

Next, as illustrated in FIG. 2C, the desiccant concentration can relatively slowly be increased (e.g., in a thermal regeneration system, by increasing the quality and/or amount of heat entering the desorber via the pre-heated air 214, e.g., by raising the heat of the condenser, as illustrated by the line connecting 213 and 214′ and extending further to the right, i.e., from 214 to 214′). As long as the desorber moisture rejection rate 233 exceeds the absorber moisture removal rate 232 the desiccant will continue to concentrate. Accordingly, the absorber moisture removal rate 232 will continue to increase until the system regains equilibrium; the desorber moisture rejection rate 233 is set, and thereby the temperature of the air used for regeneration 214′, to meet the desired supply air conditions 212″. As the desiccant concentrates the additional cooling just previously applied can be scaled back, e.g., from 211′ to 211″, to meet the target dew point and temperature in an energy efficient manner.

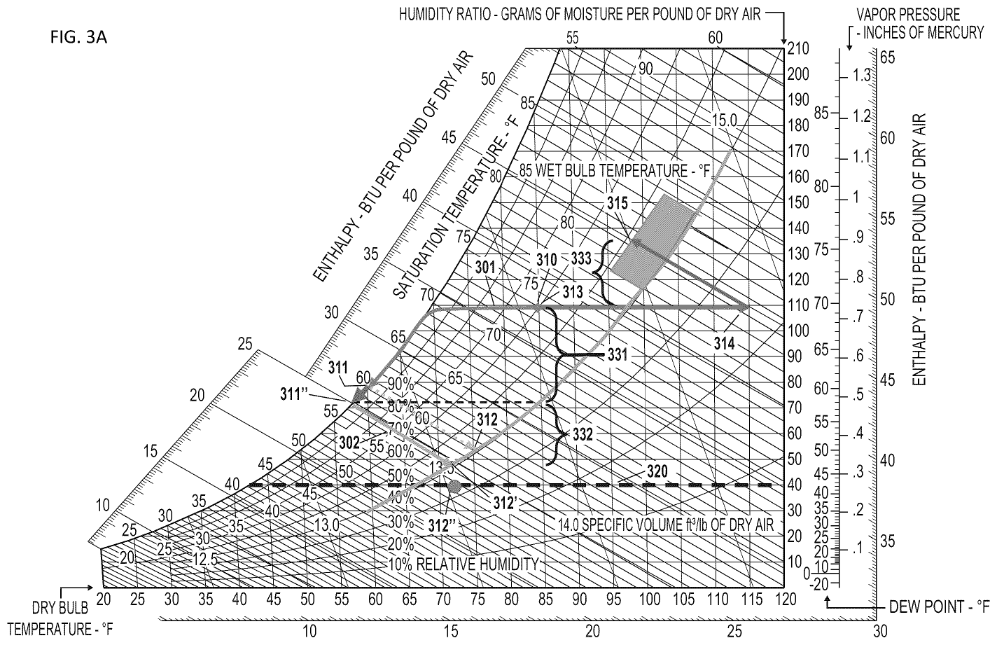

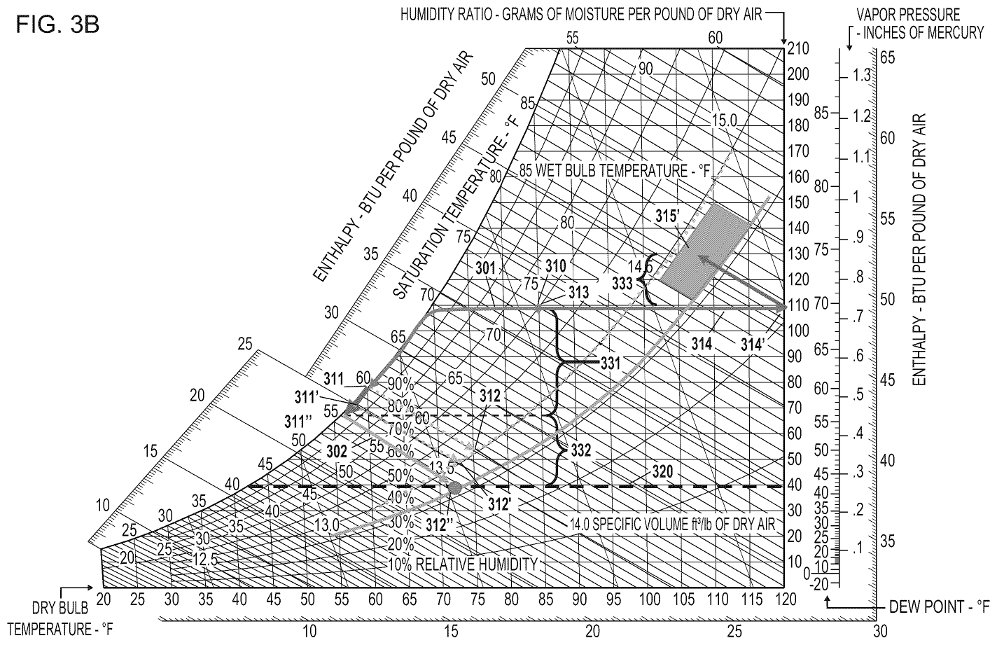

FIGS. 3A and 3B demonstrate another operation mode of a liquid desiccant system 300, e.g., one that gives priority to the supply dry bulb temperature rather than the supply air dew point. The liquid desiccant system 300 can be structurally and/or functionally similar to the liquid desiccant system 100 and/or 200 described above. For example, the liquid desiccant system 300 can include one or more components that are structurally and/or functionally similar to components of such system. Consequently, no further details regarding the components of the liquid desiccant system 300 are provided herein. In FIG. 3A. the supply air conditions are changed from FIG. 2A from about 75 degrees F. dry bulb and about 50 degrees F. dew point (212) to about 73 degrees F. dry bulb and about 40 degrees F. dew point (312″), e.g., by an operator who desires less humid air or by a controller with a schedule of temperature set points. The system gives priority to reaching the target dry bulb temperature of 73 degrees F. (312′) by relatively quickly lowering the temperature of the air leaving the cooling unit from 311 to 311′. As a result, the supply air 312′ leaving the absorber is at the target dry bulb temperature point (312′), but the supply air 312′ dew point for the supply air has only decreased to about 45 degrees, and has not yet reached the target dew point 312″.

Next, as illustrated in FIG. 3B, the desiccant concentration can relatively slowly be increased (e.g., in a thermal regeneration system, by increasing the quality and/or amount of heat entering the desorber via the pre-heated air stream 114, e.g., by raising the heat of the condenser, as illustrated by the line connecting 313 and 314′ and extending further to the right, i.e., from 314 to 314′). As long as the desorber moisture rejection rate 333 exceeds the absorber moisture removal rate 332 the desiccant will continue to concentrate. Accordingly, the absorber moisture removal rate 332 will continue to increase until the system regains equilibrium; the desorber moisture rejection rate 333 is set, and thereby the temperature of the air used for regeneration 314′, to meet the desired supply air conditions 312″. As the desiccant concentrates the additional cooling just previously applied can be decreased, e.g., from 311′ to 311″, to meet the target dew point and temperature in an energy efficient manner.

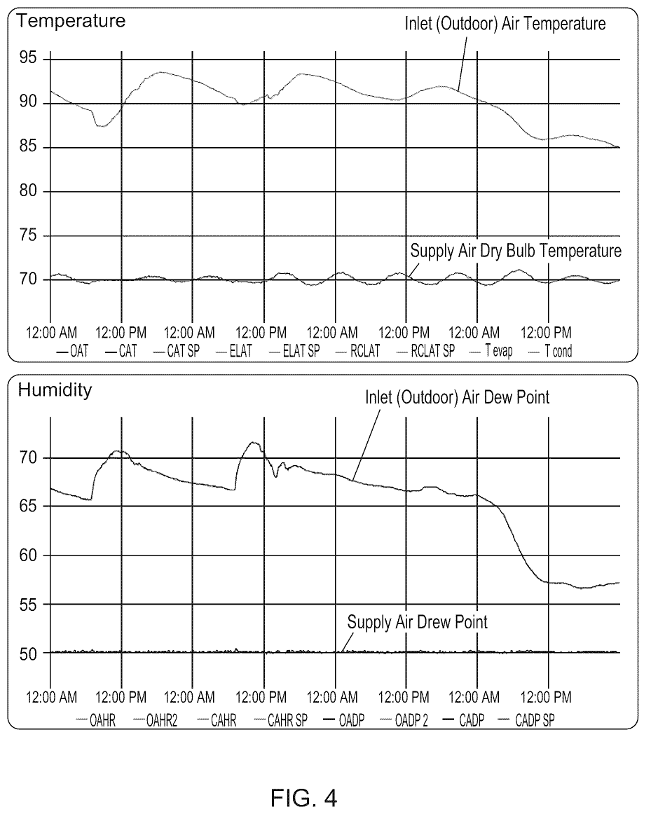

FIG. 4 shows the performance of a liquid desiccant system 400. The liquid desiccant system 400 can be structurally and/or functionally similar to other liquid desiccant systems including, for example, the liquid desiccant system 100, 200 and/or 300 described herein. For example, the liquid desiccant system 400 can include one or more components that are structurally and/or functionally similar to components of such systems. Consequently, no further details regarding the components of the liquid desiccant system 400 are provided herein. In some embodiments over a relatively long period (e.g., multiple days) the liquid desiccant system 400 may be able to hold the supply air temperature and dew point to within one degree Fahrenheit of the desired (and/or target) supply air dry bulb temperature and one degree Fahrenheit of the desired (and/or target) dew point. FIG. 4 shows the performance of the liquid desiccant system 400 operating on an inlet air stream (e.g., similar to the inlet air 110) operating continuously over an extended period of time. FIG. 4 shows the inlet (i.e., outdoor) air temperature and the inlet (i.e., outdoor) air dew point of the inlet air stream. Despite variations of over 10 degrees Fahrenheit in both temperature and dew point of the inlet air stream the liquid desiccant system 400 produces a supply air stream (e.g., similar to the supply air 112) characterized by a dry bulb temperature and dew point that remain within one degree Fahrenheit of the desired (e.g., target) conditions. The mode of operation of the liquid desiccant system 400 in FIG. 4 represents the conditioning procedure described in FIG. 2, where the dew point is given priority and the control system rapidly changes the evaporator temperature to maintain the dew point while more slowly changing the desiccant concentration. The relatively more stable dew point of the supply air stream is thus demonstrated.

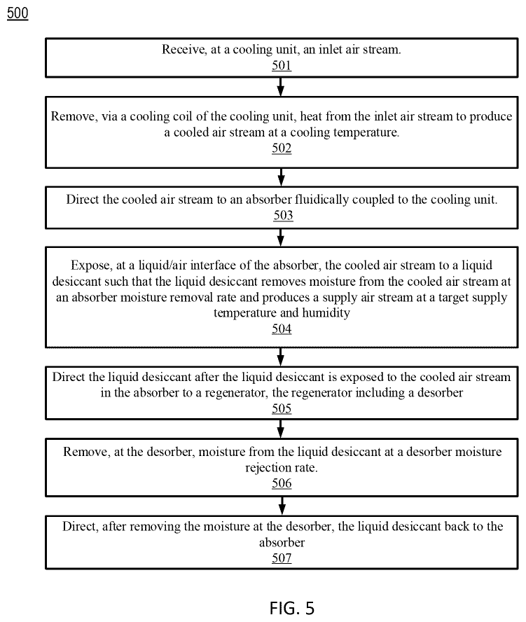

FIG. 5 shows a method 500 for conditioning a supply air stream with a liquid desiccant system 500. The liquid desiccant system 500 can be structurally and/or functionally similar to other liquid desiccant systems including, for example, the liquid desiccant system 100, 200, 300, and/or 400 described herein. For example, the liquid desiccant 500 can include one or more components that are structurally and/or functionally similar to components such systems. Consequently, no further details regarding the components of the liquid desiccant system 500 are provided herein. At step 501, the method 500 includes receiving at a cooling unit (e.g., a cooling unit similar to and/or the same as cooling unit 101) an inlet air stream. In some embodiments, the inlet air stream received at the cooling unit 501 can be characterized by specific temperature and/or humidity conditions. For example, in some embodiments the inlet air stream 510 can be characterized by a dry bulb temperature of about 85° F., and a dew point of about 70° F.

At step 502, the method 500 includes removing, via a cooling coil of the cooling unit, heat from the inlet air stream to produce a cooled air stream at a cooling temperature. In some embodiments a cooling unit can be operably coupled to a control unit (e.g., a controller 104) such that the control unit can adjust an amount and/or quality of heat removed from the inlet air stream. In that way, the liquid desiccant system 500 may produce a supply air stream (e.g., a supply stream 112) at a target supply temperature and humidity. For example, in some instances, a desired temperature and humidity (e.g., a desired dew point and/or a desired dry bulb temperature) can be selected by an operator who desires less and/or more humid air, or by a controller with a schedule of temperature set points. In some instances the control unit can change the amount and/or quality of heat removed from the inlet air stream to adjust the target supply temperature and humidity of the supply air stream such that the target supply temperature is kept within 0.1 degrees, within 0.15 degrees, within 0.2 degrees, within 0.25 degrees, within 0.3 degrees, within 0.5 degrees, within 1.0 degree, within 1.5 degrees, within 2.0 degrees, or within 5.0 degrees of the desired dew point, inclusive of all values and ranges therebetween (for temperatures measured in degrees ° F.). Additionally and/or alternatively, in some instances the control unit can change the amount and/or quality of heat removed from the inlet air stream to adjust the target supply temperature and humidity of the supply air stream such that the target supply temperature is kept within 0.1 degrees, within 0.15 degrees, within 0.2 degrees, within 0.25 degrees, within 0.3 degrees, within 0.5 degrees, within 1.0 degree, within 1.5 degrees, within 2.0 degrees, or within 5.0 degrees of the desired dry bulb temperature of the supply air stream, inclusive of all values and ranges therebetween for temperatures measured in degrees OF.

In some embodiments, the method 500 can optionally include a step 502a (not shown in FIG. 4). At the optional step 502a, the method 500 includes changing, with a control unit operably coupled to the cooling unit, an absorber, and a regenerator, the cooling temperature of the cooled air stream in the cooling unit to adjust an enthalpy change of the supply air stream. In some embodiments the cooling temperature of the cooled air stream can be changed, for example, by changing (e.g., increasing and/or reducing) a mass flowrate of a refrigerant circulating within the cooling coil of the cooling unit. The changes in the mass flowrate of the refrigerant in the cooling coil of the cooling unit can change the cooling temperature of the cooled air stream. Furthermore, in some embodiments, the mass flowrate of the refrigerant can be changed by changing a speed of the refrigerant compressor.

At step 503, the method 500 includes directing the cooled air stream to an absorber (e.g., similar to the absorber 102) fluidically coupled to the cooling unit. The absorber can define a liquid/air and/or liquid/gas interface formed by any vapor/liquid mass transport unit operation, including, for example, packed beds, tray towers, spray towers, bubble columns, membranes, and/or the like. At step 504, the method 500 further includes exposing, at the liquid/air interface of the absorber, the cooled air stream to a liquid desiccant such that the liquid desiccant removes moisture from the cooled air stream at an absorber moisture removal rate and produces a supply stream at a target supply temperature and humidity.

At step 505, the method 500 includes directing the liquid desiccant after the liquid desiccant is exposed to the cooled air stream in the absorber (at step 504) to a regenerator, the regenerator including a desorber. In some embodiments, the liquid desiccant is directed to the regenerator after the liquid desiccant is exposed to the cooled air stream in the absorber with the purpose of removing moisture of the liquid desiccant.

At step 506, the method 500 includes removing, at the desorber, moisture from the liquid desiccant at a desorber moisture rejection rate. In some embodiments, removing moisture from the liquid desiccant at the desorber includes flowing a regeneration stream through a heating unit (e.g., similar to the heating unit 103A) to produce a pre-heated air stream. The pre-heated air stream can be then directed to the desorber. At the desorber, the pre-heated air stream can be exposed to the liquid desiccant after the liquid desiccant is flown in the absorber (and thus containing moisture removed at the absorber moisture removal rate) to remove the water from the liquid desiccant and thus regenerate the liquid desiccant. In some embodiments, the heating unit can be coupled to the desorber and the cooling unit of the liquid desiccant system 500. The heating unit can include a fan and a heating coil. The heating coil can be a condenser of a heating pump configured to transfer heat from the cooling unit (e.g., heat removed to the inlet air stream) to the regeneration stream thus heating the regeneration stream and producing a pre-heated stream at a pre-heated air stream temperature. In some embodiments, the heating unit can be operably coupled to a control unit to adjust and/or change the amount and quality of heat transferred to the regeneration stream. For example, in some embodiments, the control unit can adjust and/or change the amount of heat transferred to the regeneration stream by changing a target temperature of the pre-heated air stream.

In some embodiments, the temperature of the pre-heated air stream can be adjusted and/or changed with the aid of an optional auxiliary condensing coil operably coupled to the liquid desiccant system 500. In such embodiments, the control unit can be operably coupled to the cooling unit, the absorber, the regenerator, and the auxiliary condensing coil. The control unit can send signals to the auxiliary condensing coil such that the auxiliary condensing coil flows an external air stream through the heating unit to remove a portion of the heat transferred from the cooling unit. In some instances, the portion of the heat removed from cooling unit can be unwanted and/or unneeded heat by the desiccant liquid system 500. In some embodiments, the portion of heat removed by the external air stream can be adjusted by varying a speed of a fan (e.g., a fan coupled to the auxiliary condensing coil) drawing the external air stream through the auxiliary condensing coil. Alternatively, and/or optionally, in some embodiments the portion of heat removed by the external air stream can be adjusted by (a) varying a pressure drop of the external air stream, and/or (b) by changing an amount of refrigerant flowing through the auxiliary condensing coil. Lastly, at step 507, the method 500 includes directing, after removing the moisture at the desorber, the liquid desiccant back to the absorber. Directing the liquid desiccant back to the desorber after removing its moisture facilitates the continuous removal of moisture via the exposing the liquid desiccant to the cooled air stream.

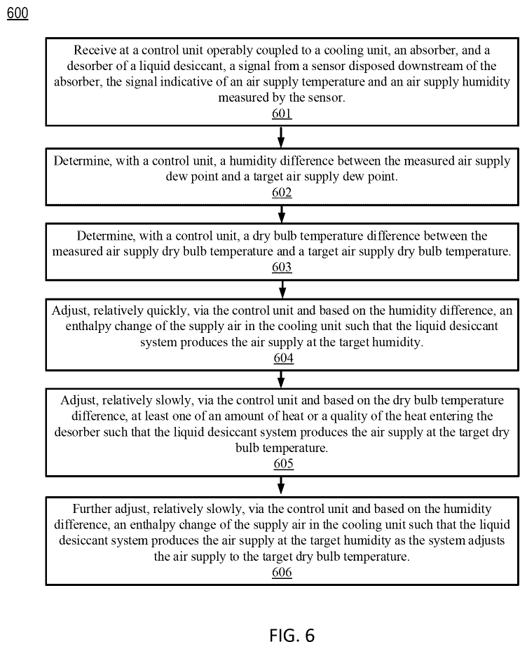

FIG. 6 shows a method 600 of operating a liquid desiccant system to produce an air supply stream, e.g., as shown in and described with respect to, FIG. 2. The liquid desiccant system 600 can be structurally and/or functionally similar to other liquid desiccant systems including, for example, the liquid desiccant system 100, 200, 300, 400 and/or 500 described herein. For example, the liquid desiccant 600 can include one or more components that are structurally and/or functionally similar to components such systems. Consequently, no further details regarding the components of the liquid desiccant system 600 are provided herein. At step 601, the method includes receiving, at a control unit operably coupled to a cooling unit, an absorber, and a desorber of the liquid desiccant system, a signal from a sensor disposed downstream of the absorber, the signal indicative of an air supply temperature and an air supply humidity measured by the sensor. In some implementations, the method 600 enables balancing the amount of moisture absorbed by a liquid desiccant in an absorber and removed from the liquid desiccant in a desorber (with the absorber and the desorber being similar to and/or the same as the absorber 102 and the desorber 103B described above with reference to FIG. 1). The control unit can be similar to and/or the same as the controller 104 described above with reference to FIG. 1. For example, the control unit can be operably coupled (e.g., physically and/or wirelessly/remotely) to the cooling unit (e.g., a cooling unit similar to the cooling unit 101), the absorber (e.g., an absorber similar to the absorber 102), the desorber (e.g., a desorber similar to the desorber 103B), and/or a heating unit (e.g., similar to the heating unit 103A) of the liquid desiccant system. Optionally, in some implementations the control unit can also be operably coupled to an external heating unit. In such embodiments, the external heating unit can be coupled to the liquid desiccant system and configured to remove an amount of excess heat from the system. In some implementations the control unit can also be operatively coupled to one or more sensors (e.g., similar to and/or the same as the sensors S with respect to FIG. 1). The control unit can be configured to send signals to and/or receive signals from the cooling unit, the absorber, the regenerator, and the sensors S, to monitor and control operation (e.g., setpoints) of the same. The sensor can be any suitable sensor or set of sensors capable of measuring various system conditions, including, for example, temperature, humidity, pressure, and/or any other suitable parameters to assist in operation and control of the liquid desiccant system. In some implementations the sensor (or at least one sensor from a set of sensors) can be disposed downstream of the absorber. In such implementations, the sensor disposed downstream of the absorber can be configured to measure one or more characteristics of a supply stream (e.g., similar to the supply stream 110) produced by the liquid desiccant system. For example, the sensor can be configured to measure an air supply temperature, and/or an air supply humidity. The sensor, can be coupled to the control unit such that the control unit can receive a signal (e.g., one or more signals) indicative of the measured air supply temperature and/or air supply humidity (e.g., report the measured temperature and humidity to the control unit). In some embodiments, the sensors can measure the air supply temperature, and send signals to the control unit indicative and/or associated with the temperature measured in degrees Celsius and/or in degrees Fahrenheit.

At step 602, the method includes determining, with the control unit, a humidity difference between the measured air supply humidity and a target air supply humidity. In some embodiments, the control unit can receive the measured air supply humidity and compare it to a target air supply humidity (e.g., a desired humidity) selected, for example, by a user of the liquid desiccant system. The target air supply humidity can be stored in a memory of the control unit. The control unit can determine a difference (e.g. a humidity difference) between the measured air supply humidity and the target air supply humidity. In some embodiments the humidity difference determined by the control unit can be used to adjust the operation of one or more components the liquid desiccant system, as further described herein.

At step 603, the method includes determining, with the control unit, a temperature difference between the measured air supply temperature and a target air supply temperature. In some embodiments, the control unit can receive the measured air supply temperature and compare it to a target air supply temperature (e.g., a desired temperature) selected, for example, by a user of the liquid desiccant system. The target air supply temperature can be stored in a memory of the control unit. In some implementations, the target air supply temperature can be a desired air supply dew point (e.g., a target dew point). In some embodiments, the target air supply temperature can be a desired dry bulb temperature (e.g., a target dry bulb temperature). The control unit can determine a difference (e.g. a temperature difference) between the measured air supply temperature and the target air supply temperature. In some embodiments the temperature difference determined by the control unit can be used to adjust the operation of one or more components the liquid desiccant system, as further described herein.

At step 604, the method includes adjusting relatively quickly, via the control unit and based on the humidity difference, an enthalpy change of the supply air in the cooling coil. This corresponds, for example, to the change shown in FIG. 2B indicated by the arrow from point 211 to 211′ and results in the supply air quickly reaching the target outlet humidity provided such as displayed as point 212′, namely the target dew point of 40° F., in this example.

At step 605, the method includes adjusting, relatively slowly, via the control unit and based on the dry bulb temperature difference, at least one of an amount of heat or a quality of the heat entering the desorber. This corresponds, for example, to the change shown in FIG. 2C indicated by the arrow from point 214 to 214′ and results in the supply air relatively slowly reaching the target outlet temperature provided such as displayed as point 212″, namely the about 73° F., in this example.

At step 606, the method includes further adjusting, relatively slowly, via the control unit and based on the humidity difference, an enthalpy change of the supply air in the cooling unit. This corresponds, for example, to the change shown in FIG. 2C indicated by the arrow from point 211′ to 211″ and results in the supply air humidity maintaining the target dew point of about 40° F. as shown by the points 212′ and 212″ and all points in between as the system relatively slowly reaching the target outlet dew point and temperature provided such as displayed as point 212″, namely the target dew point of about 40° F. and the target dry bulb temperature of about 73° F., in this example.

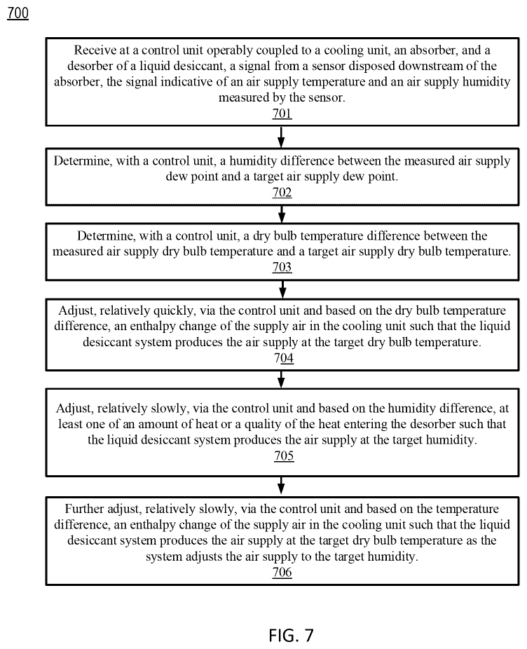

FIG. 7 shows a method 700 of operating a liquid desiccant system to produce an air supply stream, e.g., as shown in and described with respect to FIG. 3. Steps 701, 702, and 703 in method 700 are identical to steps 601, 602, and 603 in method 600.

At step 704, the method includes adjusting relatively quickly, via the control unit and based on the dry bulb temperature difference, an enthalpy change of the supply air in the cooling coil. This corresponds, for example, to the change shown in FIG. 3B indicated by the arrow from point 311 to 311′ and results in the supply air quickly reaching the target outlet dry bulb temperature provided such as displayed as point 312′, namely the about 73° F. in this example.

At step 705, the method includes adjusting, relatively slowly, via the control unit and based on the humidity difference, at least one of an amount of heat or a quality of the heat entering the desorber. This corresponds, for example, to the change shown in FIG. 3B indicated by the arrow from point 314 to 314′ and results in the supply air relatively slowly reaching the target outlet dew point provided such as displayed as point 312″, namely the target dew point of 40° F., in this example.

At step 706, the method includes further adjusting, relatively slowly, via the control unit and based on the humidity difference, an enthalpy change of the supply air in the cooling unit. This corresponds, for example, to the change shown in FIG. 3B indicated by the arrow from point 311′ to 311″ and results in the supply air dry bulb maintaining the target dew point of about 40° F. as shown by the points 312′ and 312″ and all points in between as the system relatively slowly reaching the target outlet temperature and dew point provided such as displayed as point 312″, namely the about 73° F. dry bulb temperature and the target dew point of 40° F., in this example.

While various embodiments have been described above, it should be understood that they have been presented by way of example only, and not limitation. While the embodiments have been particularly shown and described, it will be understood that various changes in form and details may be made. Where schematics and/or embodiments described above indicate certain components arranged in certain orientations or positions, the arrangement of components may be modified. Although various embodiments have been described as having particular features and/or combinations of components, other embodiments are possible having a combination of any features and/or components from any of embodiments as discussed above

As used in this specification and/or any claims included herein, the singular forms “a,” “an,” and “the” include plural referents unless the context clearly dictates otherwise. Thus, for example, the term “a member” is intended to mean a single member or a combination of members, “a material” is intended to mean one or more materials, and/or the like.

As used herein, the phrase “and/or” should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” phrase, whether related or unrelated to those elements specifically identified. Thus, as a non-limiting example, a reference to “A and/or B”, when used in conjunction with open-ended language such as “comprising” or “including” can refer, in one embodiment, to A only (optionally including elements other than B); in another embodiment, to B only (optionally including elements other than A); in yet another embodiment, to both A and B (optionally including other elements); etc.

As used herein, the term, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

As used herein, the terms “about,” “approximately,” and/or “substantially” when used in connection with stated value(s) and/or geometric structure(s) or relationship(s) is intended to convey that the value or characteristic so defined is nominally the value stated or characteristic described. In some instances, the terms “about,” “approximately,” and/or “substantially” can generally mean and/or can generally contemplate a value or characteristic stated within a desirable tolerance (e.g., plus or minus 10% of the value or characteristic stated). For example, a value of about 0.01 can include 0.009 and 0.011, a value of about 0.5 can include 0.45 and 0.55, a value of 7 about 10 can include 9 to 11, and a value of about 1000 can include 900 to 1100. Similarly, a first surface may be described as being substantially parallel to a second surface when the surfaces are nominally parallel. While a value, structure, and/or relationship stated may be desirable, it should be understood that some variance may occur as a result of, for example, manufacturing tolerances or other practical considerations (such as, for example, the pressure or force applied through a portion of a device, conduit, lumen, etc.). Accordingly, the terms “about,” “approximately,” and/or “substantially” can be used herein to account for such tolerances and/or considerations.

As used herein the term “humidity” when used to describe the condition of air or an air stream can refer to any conventional description of the moisture content of that air included but not limited to the relative humidity, the humidity ratio expressed as a ratio, the humidity ratio expressed as grains per pound, or the dew point.

1.-5. (canceled)

6. A method, comprising:
receiving, at a cooling unit, an inlet air stream;
reducing, via a cooling coil of the cooling unit, enthalpy of the inlet air stream to produce a cooled air stream at a target enthalpy;
directing the cooled air stream to an absorber that is fluidically coupled to the cooling unit;
exposing, at a liquid/air interface of the absorber, the cooled air stream to a liquid desiccant such that the liquid desiccant removes moisture from the cooled air stream at an absorber moisture removal rate and produces a supply air stream at a target relative humidity;
directing the liquid desiccant after the liquid desiccant is exposed to the cooled air stream in the absorber to a regenerator, the regenerator including a desorber;
removing, at the desorber, moisture from the liquid desiccant at a desorber moisture rejection rate; and
directing, after removing the moisture at the desorber, the liquid desiccant back to the absorber.

7. The method of claim 6, further comprising:
receiving, at a control unit operably coupled to the cooling unit, the absorber, and the regenerator, a signal from a sensor, the signal indicative of a temperature and a humidity parameter of the supply air stream measured by the sensor;
determining, with the control unit, an enthalpy difference between (1) an enthalpy associated with the measured supply air stream temperature and humidity parameter, and (2) the target enthalpy;
determining, with the control unit, a relative humidity difference between (1) a relative humidity associated with the measured supply air stream temperature and humidity parameter and (2) the target relative humidity; and
adjusting, via the control unit and based on at least one of the enthalpy difference or the relative humidity difference (1) the concentration of the desiccant in the absorber or desorber, or (2) an enthalpy change performed by the cooling unit, to produce the supply air stream at the target enthalpy and the target relative humidity.

8. The method of claim 7, wherein the relative humidity difference is kept to less than about 4 percent.

9. The method of claim 7, wherein the relative humidity difference is kept to less than about 2 percent.

10. The method of claim 7, wherein the relative humidity difference is kept to less than about 0.5 percent.

11. The method of claim 7, wherein the enthalpy difference is kept to less than about 0.6 BTU/lbs.

12. The method of claim 7, wherein the enthalpy difference is kept to less than about 0.3 BTU/lbs.

13. The method of claim 7, wherein the enthalpy difference is kept to less than about 0.06 BTU/lbs.

14. The method of claim 7, wherein the concentration of the desiccant is changed by increasing or decreasing a moisture removal rate of the desorber.

15. The method of claim 14, wherein:
increasing the moisture removal rate of the desorber includes increasing one of a temperature of pre-heated air, a mass flow rate of the pre-heated air, or a liquid desiccant flow rate; and
decreasing the moisture removal rate of the desorber includes decreasing one of the temperature of the pre-heated air, the mass flow rate of the pre-heated air, or the liquid desiccant flowrate.

16. A method for optimizing total energy usage of a liquid desiccant system, the liquid desiccant system including a cooling unit, an absorber, a regenerator, and a control unit operably coupled to the cooling unit, the absorber, and the regenerator, the cooling unit configured to receive an inlet air stream and produce a cooled air stream, the absorber configured to contact the cooled air stream with a liquid desiccant to remove moisture from the cooled air stream and produce a supply air stream at a target humidity, the method comprising:
receiving, at the control unit, at least one of a supply air target humidity ratio or a supply air target dew point; and
varying, in response to the receiving and with the control unit, the temperature of the supply air stream while minimizing the total energy usage of the liquid desiccant system.

17. The method of claim 16, wherein:
the regenerator includes a desorber fluidically coupled to the absorber, the desorber configured to expose the liquid desiccant, after the liquid desiccant is contacted with the cooled air stream, to a pre-heated air to remove moisture from the liquid desiccant at a moisture removal rate, the method further comprising:
varying the temperature of the supply air stream includes (1) increasing, via the control unit, the temperature of the supply air stream by simultaneously reducing an enthalpy change of the supply air stream performed by the cooling unit and increasing the concentration of the desiccant in one or both of the absorber or desorber, or (2), decreasing, via the control unit, the temperature of the supply air stream by simultaneously increasing the enthalpy change of the supply air stream and decreasing the concentration of the desiccant in the absorber and/or desorber.

18. The method of claim 17, wherein the concentration of the desiccant is changed by increasing or decreasing the moisture removal rate of the desorber.

19. The method of claim 18, wherein:
increasing the moisture removal rate of the desorber includes increasing one of a temperature of the pre-heated air, a mass flow rate of the pre-heated air, or a liquid desiccant flow rate; and
decreasing the moisture removal rate of the desorber includes decreasing one of the temperature of the pre-heated air, the mass flow rate of the pre-heated air, or the liquid desiccant flowrate.

20. The method of claim 17, wherein reducing the enthalpy change of the supply air stream performed by the cooling unit causes the cooled air stream to have a dew point temperature below a dew point temperature of the inlet air stream such that the cooling unit removes moisture at a condensate moisture removal rate.

21. A method of operating a liquid desiccant system to adjust one or both of a temperature or a humidity of a supply air stream, the liquid desiccant system including a cooling unit, an absorber, a regenerator, and a control unit operably coupled to the cooling unit, the absorber, and the regenerator, the method comprising:
receiving, at the control unit, a target temperature and a target humidity of the supply air stream;
measuring, with a sensor disposed downstream of the absorber, a temperature and a humidity of the supply air stream;
calculating, with the control unit, a temperature difference between the measured temperature and the target temperature of the supply air stream, and a humidity difference between the measured humidity and the target humidity of the supply air stream;
determining, with the control unit, a mode of operating the liquid desiccant system that reduces the temperature difference and the humidity difference; and
implementing, via the control unit, the mode of operating the liquid desiccant system.

22. The method of claim 21, wherein implementing the mode of operating the liquid desiccant system includes adjusting, via the control unit, a moisture removal rate of the desorber to minimize a time required to adjust the one or both of temperature or humidity of the supply air stream.

23. The method of claim 22, wherein:
the moisture removal rate of the desorber is maximized by at least one of (1) maximizing the quantity and/or quality of the pre-heated air, (2) optimizing the mass flow rate of the pre-heated air to maximize moisture removal given the available heat, or (3) adjusting a liquid desiccant flow rate; or
the moisture removal rate of the desorber is minimized by at least one of (1) minimizing the quantity and/or quality of the pre-heated air, (2) optimizing the mass flow rate of the pre-heated air, potentially to zero mass flow, to maximize moisture removal given the available heat, or (3) adjusting a liquid desiccant flow rate.

24. The method of claim 21, wherein implementing the mode of operating the liquid desiccant includes adjusting, via the control unit, a moisture removal rate of the desorber to minimize a total energy required to adjust the one or both of the temperature and humidity of the supply air stream.

25. The method of claim 24, wherein the moisture removal rate of the desorber is set equal to a moisture collection rate of the absorber when the temperature difference and the humidity difference are eliminated or reduced substantially.

26. The method of claim 25, wherein:
increasing the moisture removal rate of the desorber includes increasing one of a temperature of the pre-heated air, a mass flow rate of the pre-heated air, or a liquid desiccant flow rate; and
decreasing the moisture removal rate of the desorber includes decreasing one of the temperature of the pre-heated air, the mass flow rate of the pre-heated air, or the liquid desiccant flowrate.

27. A method of operating a liquid desiccant system to produce a supply air, the liquid desiccant system including a first and a second moisture removal device operably coupled to a control unit, the method comprising:
receiving, at the control unit, a signal from a sensor disposed downstream of the second moisture removal device, the signal indicative of a supply air temperature and humidity measured by the sensor;
determining, with the control unit, a temperature difference between the measured supply air temperature and a target supply air temperature;
determining, with the control unit, a humidity difference between the measured supply air humidity and a target air supply humidity; and
increasing, via the control unit and based on at least one of the temperature difference or the humidity difference, a first moisture removal rate at the first moisture removal device such that a second moisture removal rate at the second moisture removal device is minimized to produce the supply air at the target temperature and humidity.

28. The method of claim 27, wherein the first moisture removal device includes a cooling unit, the cooling unit configured to cool an inlet air to produce a cooled air, and the first moisture removal rate at is increased by decreasing a cooling temperature of the inlet air.

29. The method of claim 28, wherein the second moisture removal device includes an absorber fluidically coupled to a regenerator, the absorber configured to contact the cooled air with a liquid desiccant to remove moisture from the cooled air at the second moisture removal and produce the supply air, the regenerator configured to regenerate the liquid desiccant after the liquid desiccant is contacted with the cooled air, and a liquid desiccant flow rate in the regenerator is reduced.

30. The method of claim 29, wherein the regenerator is configured to contact the liquid desiccant with a regeneration air stream, and a rate of regeneration of liquid desiccant is increased by increasing an amount or a quality of heat added to the regeneration air stream.

31. The method of claim 30, wherein, when the regeneration rate has been maximized and the measured supply dewpoint or humidity ratio is greater than the target dew point or humidity ratio, the first moisture removal rate is increased by decreasing the cooling temperature such that the difference in humidity is eliminated.

32. A method of operating a liquid desiccant system, comprising:
receiving, at a cooling unit, an inlet air stream;
reducing, via a cooling coil of the cooling unit, enthalpy of the inlet air stream to produce a cooled air stream at a target enthalpy;
directing the cooled air stream to an absorber that is fluidically coupled to the cooling unit;
eliminating the flow of the liquid desiccant in the absorber to reduce an absorber moisture removal rate;
exposing, at a liquid/air interface of the absorber, the cooled air stream to a liquid desiccant such that residual liquid desiccant removes moisture from the cooled air stream at a residual absorber moisture removal rate and produces a supply air stream; and
intermittently, to remove the moisture gathered by the residual absorber desiccant:
directing the liquid desiccant after the liquid desiccant is exposed to the cooled air stream in the absorber to a regenerator, the regenerator including a desorber;
removing, at the desorber, moisture from the liquid desiccant at a desorber moisture rejection rate; and
directing, after removing the moisture at the desorber, the liquid desiccant back to the absorber.

33. The method of claim 32, where the moisture gathered by the residual absorber desiccant is removed by intermittently activating a desiccant pump in the regenerator.

34. The method of claim 33, where the pump is activated to start removal of the moisture gathered by the residual absorber desiccant when the liquid level rises above a certain threshold.

35. The method of claim 33, where the pump is deactivated to stop removal of the moisture gathered by the residual absorber desiccant after a fixed period of time has elapsed since the pump was activated.

36. The method of claim 33, where the pump is deactivated to stop removal of the moisture gathered by the residual absorber desiccant after the liquid level drops below a certain threshold.

37. The method of claim 33, where the pump is activated or deactivated by receiving a signal from another system.

38. The method of claim 32, where the moisture gathered by the residual absorber desiccant is removed by intermittently activating the regeneration fan in the regenerator.

39. The method of claim 32, wherein the method of operating the liquid desiccant system is a method to produce the supply air stream at a minimal supply air temperature or to increase a sensible heat ratio of the liquid desiccant system.
